(19) United States
(12) Patent Application Publication
(10) Pub. No.: US 2013/0016055 A1
(43) Pub. Date: Jan. 17, 2013

(54) WIRELESS TRANSMITTING STYLUS AND TOUCH DISPLAY SYSTEM

(71) Applicant: Chih-Hung CHUANG, Taipei (TW)

(72) Inventor: Chih-Hung CHUANG, Taipei (TW)

(21) Appl. No.: 13/549,123

(22) Filed: Jul. 13, 2012

Related U.S. Application Data
(60) Provisional application No. 61/507,314, filed on Jul. 13, 2011.

(51) Int. Cl. G06F 3/033; G06F 3/041

(52) U.S. Cl. 345/173; 345/179

(57) ABSTRACT

A wireless transmitting stylus configured to a touch control apparatus includes a motion sensing unit and a wireless transmitting unit. The motion sensing unit senses the motion of the wireless transmitting stylus so that the wireless transmitting stylus generates a motion signal. The wireless transmitting unit transmits the motion signal to the touch control apparatus, so that the touch control apparatus to trigger the execution. Accordingly, a user can grab the wireless transmission stylus and make a hand gesture to control the touch control apparatus.

### CROSS REFERENCE TO RELATED APPLICATIONS

The non-provisional patent application claims priority to U.S. provisional patent application with Ser. No. 61/507,314 filed on Jul. 13, 2011. This and all other extrinsic materials discussed herein are incorporated by reference in their entirety.

### BACKGROUND OF THE INVENTION

1. Field of Invention

The present disclosure relates to a stylus and a touch display system, and in particular, to a wireless transmitting stylus and touch display system.

2. Related Art

Touch screen is a display apparatus that allows a stylus to operate thereon so as to generate input signals. Touch screen is widely applied to portable electronics, such as mobile phones, personal digital assistants (PDA), e-readers or tablet computers. Since the stylus is quite suitable for operation on touch screen, the related electronic facilities are available on market rapidly after the technology became mature.

However, the stylus is only used to input limited signals, and the function of the stylus is still insufficient.

### SUMMARY OF THE INVENTION

This disclosure discloses a wireless transmitting stylus configured to a touch control apparatus. The wireless transmitting stylus comprises a motion sensing unit and a wireless transmitting unit. The motion sensing unit senses the motion of the wireless transmitting stylus to generate a motion signal. The wireless transmitting unit transmits the motion signal to the touch control apparatus, and triggers an execution on the touch control apparatus according to the motion signal.

Besides, the disclosure also discloses a touch display system, which comprises a touch control apparatus and a wireless transmitting stylus. The wireless transmitting stylus is configured to the touch control apparatus, and comprises a motion sensing unit and a wireless transmitting unit. The motion sensing unit senses the motion of the wireless transmitting stylus to generate a motion signal. The wireless transmitting unit transmits the motion signal to the touch control apparatus for the touch control apparatus to trigger the execution.

The wireless transmitting stylus disclosed herein comprises a motion sensing unit. Thus, a user can grab the wireless transmitting stylus and control the touch control apparatus by gestures to trigger the execution. The execution is for example but not limited to, select, copy, paste, drag, marker, save or menus pop-up. Besides, due to the wireless transmitting stylus disclosed herein comprises a wireless transmitting unit, therefore, not only the touch screen, but also any other apparatus without touch control function is adaptable with the wireless transmitting stylus for commends input.

These and other features, aspects and advantages of the present invention will become better understood with regard to the following description, appended claims, and accompanying drawings.

### BRIEF DESCRIPTION OF THE DRAWINGS

FIG. 1 is a schematic diagram of a touch display system according to a preferred embodiment of this disclosure;

FIG. 2 is a block diagram of a touch display system according to the preferred embodiment of this disclosure; and

FIG. 3 is a block diagram of another wireless transmitting stylus according to the preferred embodiment of this disclosure.

### DETAILED DESCRIPTION OF THE INVENTION

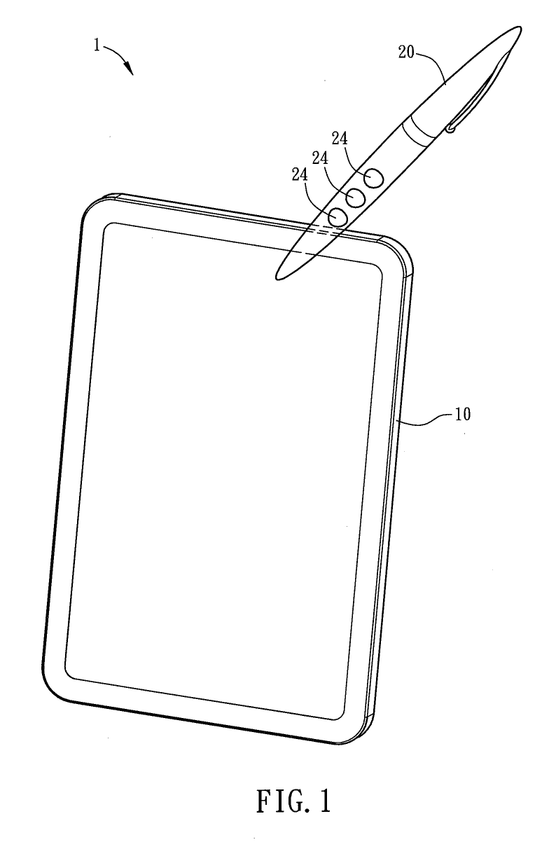

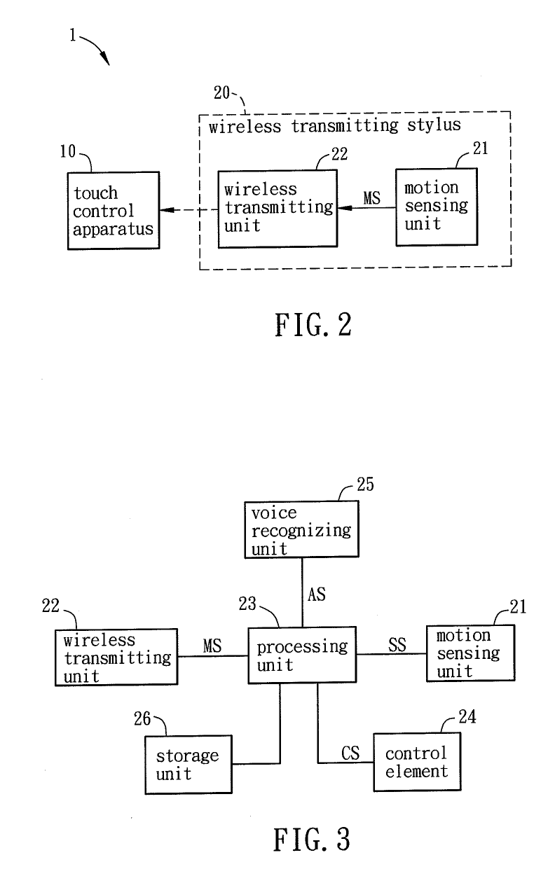

FIG. 1 is a schematic diagram of a touch display system 1 according to an embodiment of this disclosure. FIG. 2 is a block diagram of the touch display system 1. Referring to FIGS. 1 and 2, the touch display system 1 comprises a touch control apparatus 10 and a wireless transmitting stylus 20.

The disclosure has no limitation on size and touch control types. In an embodiment, the touch control apparatus 10 is, for example but not limited to, a flat TV, a mobile phone, a tablet computer or a laptop. A tablet computer is an example of touch control apparatus 10 herein.

The wireless transmitting stylus 20 is cooperated with the touch control apparatus 10; therefore, a user can control the touch control apparatus 10 by the wireless transmitting stylus 20. The shape of the wireless transmitting stylus can be any shape that can be grabbed by one hand, such as a pen shape, a cuboid, an ellipsoid, a cone and etc, which is not limited herein. In an embodiment, the wireless transmitting stylus 20 is a pen shape.

The wireless transmitting stylus 20 comprises a motion sensing unit 21 and a wireless transmitting unit 22. The motion sensing unit 21 of the wireless transmitting stylus 20 generates a motion signal MS according to the motion of the wireless transmitting stylus 20.

The motion sensing unit 21, for example, includes a gyroscope, an accelerometer, their combination, or any motion sensors. The motion signal MS, for example, includes the information such as acceleration, velocity, displacement, angle velocity, angle, route or their combinations. In this embodiment, the motion sensing unit 21 includes a gyroscope and an accelerometer for sensing the motion of the wireless transmitting stylus 20 grabbed by the user so as to generate the motion signal MS. The motion signal MS includes the information of acceleration and angle velocity. In other embodiments, the motion sensing unit 21 can calculate the motion signal MS in advance by, for example, integrating to obtain other motion information.

After the motion sensing unit 21 generates the motion signal MS, the wireless transmitting unit 22 transmits the motion signal MS to the touch control apparatus 10 to trigger the execution on the touch control apparatus 10 according to the motion signal MS. The wireless transmitting unit 22 can transmit the motion signal MS to the touch control apparatus 10 by any transmitting technology, such as Bluetooth, Wi-Fi direct or Digital Living Network Alliance (DLNA).

After receiving the motion signal MS, the touch control apparatus 10 can directly perform a corresponding function according to the motion signal MS or conduct a calculation to the motion signal MS so as to indirectly perform a corresponding function according to the motion signal MS. For example, when an acceleration value carried by the motion signal MS is larger than a predetermined value, the touch control apparatus 10 performs a corresponsive function (e.g. shut down). Otherwise, the touch control apparatus 10 may perform a calculation (e.g. integration or signal merge) on the motion signal MS to obtain a calculation information, such as a path information that indicates the moving path of the wireless transmitting stylus 20 operated by the user. Then, the touch control apparatus 10 performs a corresponsive function according to the path information. For instance, when the moving path is similar to “S”, the touch control apparatus 10 executes a save function.

The above-mentioned motion signal MS (or the further calculated information) and the corresponsive functions are only an example, and are not the limitation for the present disclosure. The touch control apparatus 10 can perform other functions, such as select, copy, paste, drag, marker, pop-up menu and etc. In other examples, the touch control apparatus 10 can check upon a look-up table to trigger a corresponding function according to the motion signal MS (or the calculated information). Wherein, the look-up table includes the corresponding relationship between the motion signal (or the calculated information) and the performed function.

FIG. 3 is a block diagram of another wireless transmitting stylus 20 according to the preferred embodiment of this disclosure. Referring to FIG. 3, the wireless transmitting stylus 20 can further comprise a processing unit 23 which is electrically connected to the motion sensing unit 21 and receives a sensing signal SS from the motion sensing unit 21 so as to generate a motion signal MS. The sensing signal SS is produced because that the motion sensing unit 21 senses the motion of the wireless transmitting stylus 20 grabbed by the user. The sensing signal SS can be, for example, acceleration, velocity, displacement, angle velocity, angle, route or their combinations.

When receiving the sensing signal SS, the processing unit 23 can generate a motion signal MS substantially the same as the sensing signal SS or further process the sensing signal SS to generate a motion signal MS. Herein, the sensing signal SS is an example of including the information of acceleration and angle velocity, and the motion signal MS is an example of the route information generated by processing the sensing signal SS.

The processing unit 23 makes the wireless transmitting unit 22 transmit the motion signal MS to the touch control apparatus 10, and then the touch control apparatus 10 performs the function according to the motion signal MS. The technology and feature about the motion signal MS and the corresponding function performed by the touch control apparatus 10 are described above, so the detailed description there of is omitted.

Besides, referring to FIG. 1 and FIG. 3, the wireless transmitting stylus 20 can further comprise a control element 24. The control element 24 is exposed from the wireless transmitting stylus 20 and is electrically connected to the processing unit 23. The control element 24 is controllable by the user. The control element 24 can include, for example, a button, a glide unit or other types of components that are operatable by users. Herein, in an embodiment, the wireless transmitting stylus 20 includes three control elements 24. The control element 24 can operated to generate a control signal CS. The processing unit 23 makes the wireless transmitting 22 transmit the control signal CS to the touch control apparatus 10.

In this embodiment, two of the three control elements 24 can function as, for example but not limited to, the left and right buttons of a mouse, that can execute the functions including click, select, pop-up menu and etc. The residual control element 24 can function as a hot key or a custom function key. After receiving the control signal CS, the touch control apparatus 10 executes at least one of the functions mentioned above.

In addition, the motion signal MS and the control signal CS may be applied at the same time. That is, the touch control apparatus 10 can perform a corresponsive function based on the received motion signal MS and control signal CS as well as their combination variations. For example, when the user presses one control element 24 and then operates the wireless transmitting stylus 20 to virtually draw the pattern “→”, the touch control apparatus 10 selects a paragraph from an article. Next, when the user clicks another control element 24, the touch control apparatus 10 displays a pop-up menu. Then, the user selects one item (e.g. paste) from the menu, and clicks this control element 24 again so as to finish the copy-paste operation. The above-mentioned motion signal MS, control signal CS and executed functions are for illustrations only, and they are not to limit the disclosure. Of course, the user can personally determine the function executed by the touch control apparatus 10 corresponding to the motion signal MS and control signal CS.

The wireless transmitting stylus 20 can further comprise a voice recognizing unit 25 which is electrically connected to the processing unit 23 and is able to recognize a voice and then generate a voice recognizing signal AS. The processing unit 23 can make the wireless transmitting unit 22 transmit the voice recognizing signal AS to the touch control apparatus 10. The voice recognizing signal AS combined with the motion signal MS and the control signal CS generates more combinations of instructions to execute more desired functions of the touch control apparatus 10. The cooperation principles are similar to that mentioned previously, so the detailed descriptions thereof are omitted.

Besides, the wireless transmitting stylus 20 further comprises a storage unit 26. The storage unit 26 is electrically connected to the processing unit 23 and stores at least one of the voice recognizing signal AS, the motion signal MS, the control signal CS and the sensing signal SS.

To be noted, the above-mentioned wireless transmitting stylus 20 composes not only the wireless transition function but also the general touch control function, so that it can be cooperated with the touch screen. The touch screen can be, for example, force sensor, resistive, capacitive, infrared, surface acoustic wave, electromagnetic or optical imaging type touch screen.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless transmitting stylus configured to a touch control apparatus, comprising:
a motion sensing unit sensing the motion of the wireless transmitting stylus to generate a motion signal; and
a wireless transmitting unit transmitting the motion signal to the touch control apparatus to trigger an execution on the touch control apparatus.

2. The wireless transmitting stylus according to claim 1, further comprising:
a processing unit electrically connected to the motion sensing unit and receiving a sensing signal of the motion sensing unit so as to generate the motion signal.

3. The wireless transmitting stylus according to claim 1, further comprising:
at least one control unit exposed from the wireless transmitting stylus for generating a control signal.

4. The wireless transmitting stylus according to claim 1, further comprising:
a voice recognizing unit for generating a voice recognizing signal which is transmitted by the wireless transmitting unit to the touch control apparatus.

5. A touch display system, comprising:
a touch control apparatus; and
a wireless transmitting stylus configured to the touch control apparatus, and comprising:
a motion sensing unit sensing the motion of the wireless transmitting stylus to generate a motion signal; and
a wireless transmitting unit transmitting the motion signal to the touch control apparatus to trigger an execution.

6. The touch display system according to claim 5, wherein the wireless transmitting stylus further comprises:
a processing unit electrically connected to the motion sensing unit and receiving a sensing signal of the motion sensing unit so as to generate the motion signal.

7. The touch display system according to claim 5, wherein the wireless transmitting stylus further comprises:
at least one control unit exposed from the wireless transmitting stylus and generating a control signal which is transmitted to the touch control apparatus via the wireless transmitting unit.

8. The touch display system according to claim 5, wherein the wireless transmitting stylus further comprises:
a voice recognizing unit for generating a voice recognizing signal which is transmitted by the wireless transmitting unit to the touch control apparatus.

9. The touch display system according to claim 5, wherein the touch control apparatus searches from a look-up table according to the motion signal to trigger the execution.
